(19) United States
(12) Patent Application Publication
(10) Pub. No.: US 2016/0291570 A1
(43) Pub. Date: Oct. 6, 2016

(54) TOOL-PATH GENERATION APPARATUS AND METHOD

(71) Applicant: MITSUBISHI ELECTRIC CORPORATION, Chiyoda-ku, Tokyo (JP)

(72) Inventors: Kenji IRIGUCHI, Tokyo (JP); Ryosuke YAMASHITA, Tokyo (JP)

(73) Assignee: MITSUBISHI ELECTRIC CORPORATION, Chiyoda-ku, Tokyo (JP)

(21) Appl. No.: 14/436,544

(22) PCT Filed: May 28, 2014
(86) PCT No.: PCT/JP2014/064156

§ 371 Date: Apr. 17, 2015

(51) Int. Cl. G05B 19/402; B23C 3/24

(52) U.S. Cl. CPC G05B 19/402; B23C 3/24; B23C 2220/52; G05B 2219/35101

(57) ABSTRACT

To provide a tool-path generation apparatus that generates a tool path for forming a concave part that is defined by an entire machining-area shape and a depth into a machining material. The tool-path generation apparatus includes a spiral-machining-path reference-circle generation unit that extracts a plurality of circular areas that satisfy a preset condition from the entire machining-area shape, a spiral-machining-path generation unit that generates a tool path for machining the circular areas extracted by the spiral-machining-path reference-circle generation unit or an area that includes a circumference of the circular areas by using a spiral path and a machining-area shape after spiral machining in which a machining area by a spiral tool path is removed from the entire machining-area shape, and a trochoidal-machining-path generation unit that generates a tool path for machining the machining-area shape after spiral machining.

### FIELD

The present invention relates to a tool-path generation apparatus and a tool-path generation method that can reduce a machining time and extend the lifetime of a tool by combining a pocket part that is defined by an entire machining-area shape defined on a two-dimensional plane and a depth with a spiral path and a trochoidal path.

### BACKGROUND

As a tool-path generation apparatus for machining a concave part that is defined by an entire machining-area shape defined on a two-dimensional plane and a depth, that is, a pocket part, a tool-path generation apparatus that generates a spiral machining path for the largest circle part in the entire machining-area shape and automatically generates a trochoidal machining path in which a machining path and a non-machining path are repeated for a part of the entire machining-area shape other than the largest circle has been conventionally known (see, for example, Patent literature 1).

The tool-path generation apparatus described above can suppress a machining load on a tool, and thus has an advantage such that high efficient machining that effectively uses a cutting edge length of a tool can be performed. Particularly in the spiral path, a machining state is maintained and thus machining is performed at a higher efficiency in the spiral path than that in the trochoidal path in which a machining state and a non-machining state are repeated.

### CITATION LIST

### Patent Literature

Patent Literature 1: Japanese Patent Application Laid-open No. 2002-283118

### SUMMARY

### Technical Problem

However, in the conventional technique described above, an efficient spiral path is applied to only the largest circle part in the entire machining-area shape, and thus there is a problem that efficiency improvement by automatically applying a plurality of spiral paths according to the entire machining-area shape cannot be realized.

The present invention has been achieved in view of the above problems, and an object of the invention is to provide a tool-path generation apparatus and a tool-path generation method that can automatically generate a plurality of spiral tool paths according to an entire machining-area shape.

### Solution to Problem

To solve the above described problem, the present invention includes a tool-path generation apparatus that generates a tool path for forming a concave part that is defined by an entire machining-area shape and a depth into a machining material. The tool-path generation apparatus includes: a reference-circle generation unit that extracts a plurality of circular areas that satisfy a preset condition from the entire machining-area shape; a first machining-path generation unit that generates a first tool path for machining the circular areas extracted by the reference-circle generation unit or an area that includes a circumference of the circular areas by using a spiral path and a machining-area shape after spiral machining in which a machining area by the first tool path is removed from the entire machining-area shape; and a second machining-path generation unit that generates a second tool path for machining the machining-area shape after spiral machining.

### Advantageous Effects of Invention

The tool-path generation apparatus and the tool-path generation method according to the present invention can automatically generate a plurality of spiral tool paths according to an entire machining-area shape, and thus the machining efficiency can be improved.

### BRIEF DESCRIPTION OF DRAWINGS

FIG. 1 shows a configuration of a tool-path generation apparatus according to an embodiment of the present invention.

FIG. 2 is a flowchart of a flow of an operation of the tool-path generation apparatus according to the embodiment.

FIG. 3 shows an example of an entire machining-area shape.

FIG. 4 shows an example of a medial axis obtained by medial axis transform.

FIG. 5 shows an example of an inscribed circle that is an extraction candidate.

FIG. 6 shows an example of circle data to be extracted.

FIG. 7 shows an example of a hole machining path.

FIG. 8 shows generation of spiral machining.

FIG. 9 shows an example of an area shape that is a machining target in a trochoidal machining.

FIG. 10 shows an example of a machining path for a trochoidal machining.

FIG. 11 shows an example of a tool path as an output result.

FIG. 12 shows an example of a tool path generated by a tool-path generation apparatus disclosed in Patent Literature 1.

FIG. 13 shows an example of a case of extracting a circle that is not tangent to the contour of an entire machining-area shape at two points.

### DESCRIPTION OF EMBODIMENTS

Exemplary embodiments of a tool-path generation apparatus and a tool-path generation method according to the present invention will be explained below in detail with reference to the accompanying drawings. The present invention is not limited to the embodiments.

### Embodiment

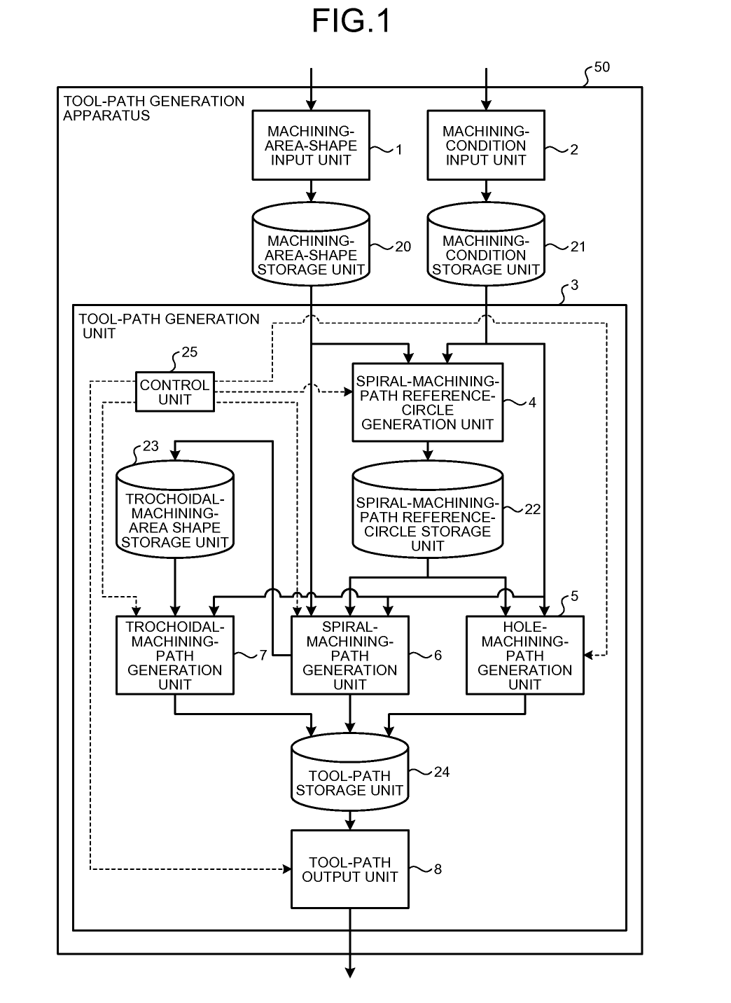

FIG. 1 shows a configuration of a tool-path generation apparatus according to an embodiment of the present invention. A tool-path generation apparatus 50 according to the present embodiment includes a machining-area-shape input unit 1, a machining-condition input unit 2, a tool-path generation unit 3, a machining-area-shape storage unit 20, and a machining-condition storage unit 21.

The machining-area-shape input unit 1 receives an external input of an entire machining-area shape data that defines the shape of the entire machining-area and stores the received data in the machining-area-shape storage unit 20.

The machining-condition input unit 2 receives external inputs of data such as: the depth of a machining part; a machining method of a hole where spiral machining starts; the radius of a hole; a machining time per hole; the diameter of an end mill tool used for helical machining, spiral machining, and trochoidal machining; parameters for generating a spiral machining path and a trochoidal machining path; a feed speed in a path where machining is performed in a spiral machining path or in a trochoidal machining path; a feed speed in a path where machining is not performed in a trochoidal machining path; and a feed speed in a path between spiral machining paths, and stores the data in the machining-condition storage unit 21. Examples of the machining method of a hole where spiral machining starts include drill machining by a drill tool and helical machining by an end mill tool. Examples of the parameters for generating a spiral machining path and a trochoidal machining path include a cutting amount in a tool radius direction and a contact angle of a tool with respect to a machining material.

The tool-path generation unit 3 includes a spiral-machining-path reference-circle generation unit 4, a hole-machining-path generation unit 5, a spiral-machining-path generation unit 6, a trochoidal-machining-path generation unit 7, a tool-path output unit 8, a spiral-machining-path reference-circle storage unit 22, a trochoidal-machining-area shape storage unit 23, a tool-path storage unit 24, and a control unit 25. The tool-path generation unit 3 controls the order of performing the respective functional units, thereby generating tool paths for hole machining, spiral machining, and trochoidal machining and outputting the tool paths to outside.

The spiral-machining-path reference-circle generation unit 4 serving as a reference-circle generation unit generates, in response to an execution instruction from the control unit 25, circle data that is the reference of a spiral machining path based on the entire machining-area shape data stored in the machining-area-shape storage unit 20 and the machining condition data stored in the machining-condition storage unit 21, and stores the circle data in the spiral-machining-path reference-circle storage unit 22.

The hole-machining-path generation unit 5 generates, in response to an execution instruction from the control unit 25, machining path data for forming a hole where spiral machining starts based on circle data stored in the spiral-machining-path reference-circle storage unit 22 and machining condition data stored in the machining-condition storage unit 21, and stores the machining path data in the tool-path storage unit 24.

The spiral-machining-path generation unit 6 serving as a first machining-path generation unit generates, in response to an execution instruction from the control unit 25, spiral machining path data as a first tool path based on the entire-machining-area shape data stored in the machining-area-shape storage unit 20, the circle data stored in the spiral-machining-path reference-circle storage unit 22, and the machining condition data stored in the machining-condition storage unit 21, and stores the spiral machining path data in the tool-path storage unit 24. Further, the spiral-machining-path generation unit 6 generates data of a machining-area shape after spiral machining serving as a trochoidal machining target, in which a machining-area shape formed by a generated path is removed from the entire machining-area shape, and stores the data in the trochoidal-machining-area shape storage unit 23.

The trochoidal-machining-path generation unit 7 generates, in response to an execution instruction from the control unit 25, trochoidal machining path data as a second tool path based on the data of a machining-area shape after spiral machining stored in the trochoidal-machining-area shape storage unit 23 and the machining condition data stored in the machining-condition storage unit 21, and stores the data in the tool-path storage unit 24.

The tool-path output unit 8 outputs the machining path data stored in the tool-path storage unit 24 to outside in response to an execution instruction from the control unit 25.

The machining-area-shape storage unit 20 stores therein the entire machining-area shape data inputted to the machining-area-shape input unit 1.

The machining-condition storage unit 21 stores therein the machining condition data inputted to the machining-condition input unit 2.

The spiral-machining-path reference-circle storage unit 22 stores therein the circle data generated in the spiral-machining-path reference-circle generation unit 4.

The trochoidal-machining-area shape storage unit 23 stores therein the data of the machining-area shape after spiral machining generated in the spiral-machining-path generation unit 6.

The tool-path storage unit 24 stores therein the machining path data generated in each of the hole-machining-path generation unit 5, the spiral-machining-path generation unit 6, and the trochoidal-machining-path generation unit 7.

The control unit 25 transmits an execution instruction to each of the spiral-machining-path reference-circle generation unit 4, the hole-machining-path generation unit 5, the spiral-machining-path generation unit 6, the trochoidal-machining-path generation unit 7, and the tool-path output unit 8, thereby controlling the operating order of the respective units.

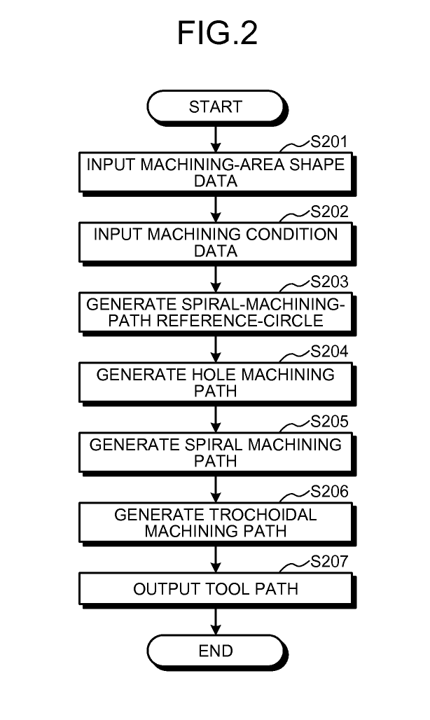

FIG. 2 is a flowchart of a flow of an operation of the tool-path generation apparatus according to the embodiment. First, data that defines an entire machining-area shape is input from outside to the machining-area-shape input unit 1 and is stored in the machining-area-shape storage unit 20 (Step S201). The data that defines the entire machining-area shape is data such as the type, coordinate, and dimension of a shape element that forms the contour shape of an area. As a method of inputting data from outside to the machining-area-shape input unit 1, an operator can input data by operating a keyboard and the like or a specified part of CAD (Computer Aided Design) data can be converted.

FIG. 3 shows an example of an entire machining-area shape. In the present embodiment, the entire machining-area shape is a shape in which two rectangular areas with rounded corners are connected to each other by a trench area. Data for forming a concave part N of the shape in which two rectangular areas with rounded corners are connected to each other by a trench area in a machining material 40 is stored in the machining-area-shape storage unit 20 as the entire machining-area shape data that defines the entire machining-area shape. It is assumed that the depth of the concave part N is a fixed value.

Next, machining condition data is input from outside to the machining-condition input unit 2 and is stored in the machining-condition storage unit 21 (Step S202). The machining condition data is input from outside by an operator operating a keyboard and the like or by a host system (such as a CAM (Computer Aided Manufacturing) device and a numerical controller).

The tool-path generation unit 3 generates circle data that is the reference of a spiral machining path in the spiral-machining-path reference-circle generation unit 4 and stores the data in the spiral-machining-path reference-circle storage unit 22 (Step S203).

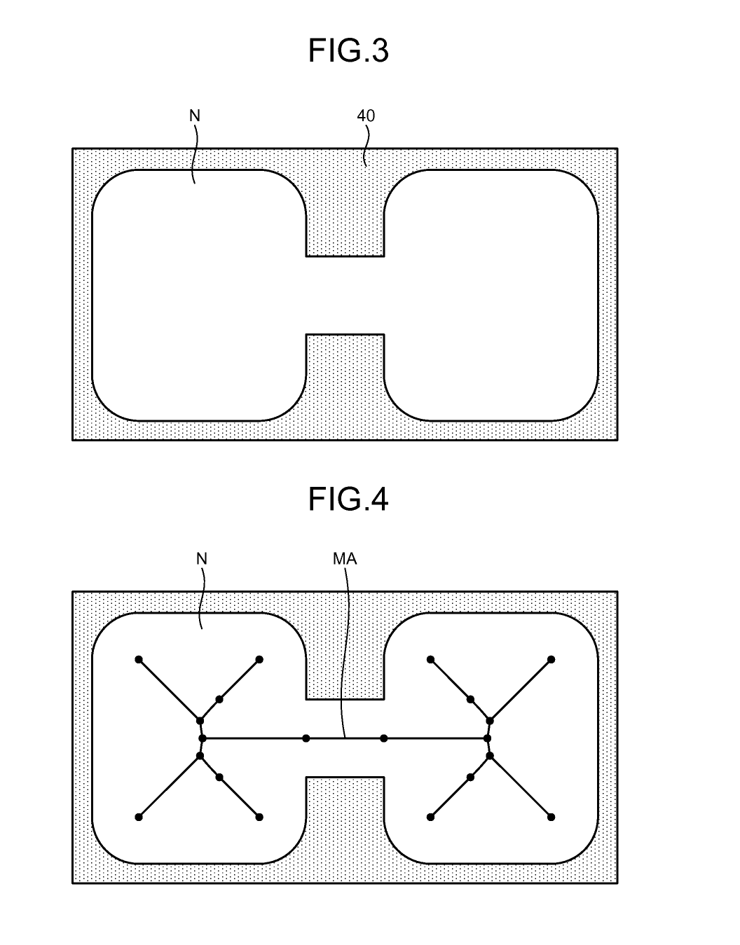

As a method of generating circle data, for example, medial axis transform that is generally known can be used. By medial axis transform, a medial axis in which the center points of inscribed circles that are tangent to a given contour shape at two or more points gathers and the radius of the inscribed circle at each point on a center line can be obtained. FIG. 4 shows an example of a medial axis obtained by medial axis transform. In FIG. 4, a medial axis MA obtained by performing medial axis transform on the machining-area-shape data of the concave part N shown in FIG. 3 is shown. A point on the medial axis MA indicates a position where the radius of an inscribed circle is increased or reduced, that is, the radius of the inscribed circle becomes the maximum value or the minimum value. The center of the inscribed circle with the largest radius that is explained later is at a position where the radius of the inscribed circle becomes the maximum value or a position where the radius of the inscribed circle becomes the minimum value.

At Step S203, circle data is extracted according to the following procedures. (a) An inscribed circle with the largest radius is extracted as a first inscribed circle from a plurality of inscribed circles based on information (specifically, a medial axis and the radius of an inscribed circle) obtained by medial axis transform. (b) Among from a second inscribed circle that is tangent to the contour of the entire machining-area shape at three or more points and a third inscribed circle that does not overlap with the second inscribed circle and is tangent to the contour of the entire machining-area shape at two points, an inscribed circle with the largest radius in inscribed circles that has a radius larger than a predetermined value and does not overlap with the extracted first, second, and third inscribed circles is extracted. (c) As a result of (b) described above, if there is no inscribed circle to be extracted, the extraction process ends, and if there is an inscribed circle to be extracted, the process returns to the procedure (b).

In the procedure (b) described above, an inscribed circle that is tangent to the contour of the entire machining-area shape at three or more points is set as an extraction candidate. This is because the inscribed circle that is tangent to the contour of the entire machining-area shape at three or more points may become an inscribed circle with the largest radius locally. Further, an inscribed circle that does not overlap with an inscribed circle that is tangent to the contour of the entire machining-area shape at three or more points and that is tangent to the contour of the entire machining-area shape at two points is set as an extraction candidate. This is because there is a sufficient space between inscribed circles that are tangent to the contour of the entire machining-area shape at three or more points and by applying spiral machining to an inscribed circle in the space, the efficiency can be improved. FIG. 5 shows an example of an inscribed circle that is an extraction candidate. In FIG. 5, the entire machining-area shape is a concave part that is an elongated hole. As shown in FIG. 5, if there is a sufficient space between inscribed circles C4 and C5 that are tangent to the contour of the entire machining-area shape, an inscribed circle C6 in the space is set as an extraction candidate.

In the procedure (b) described above, an inscribed circle to be extracted is limited to an inscribed circle that has a radius larger than a predetermined value. This is because, to secure a spiral machining allowance, the radius of an inscribed circle needs to be larger, to some extent, than that of a hole from which a spiral machining starts. For example, the predetermined value is calculated as follows by using a radius RH of a hole and a diameter DEM of an end mill tool stored in the machining-condition storage unit 21.

predetermined value=RH+K×DEM (1)

In the above formula (1), K is a constant larger than 0. If K is set to be large, the lower limit value of the radius of an inscribed circle to be extracted becomes large. Therefore, spiral machining can be performed only on an area that has a certain size and the effect of efficiency improvement by spiral machining can be increased. However, if K is too large, the number of inscribed circles that are extracted as candidates is reduced and the effect of efficiency improvement by spiral machining is reduced. Therefore, it is desirable to appropriately set K according to the entire machining-area shape and machining conditions.

In the procedure (b) described above, an inscribed circle to be extracted is limited to an inscribed circle that does not overlap with inscribed circles that have already been extracted. This is because of the following reason. If spiral machining areas overlap with each other, machining is not performed during a subsequent tool movement, resulting in a decrease in the efficiency. However, even if an inscribed circle slightly overlaps with the already extracted inscribed circle, it is presumed that the effect of efficiency improvement by spiral machining is increased. Therefore, whether there is an overlap may be determined by the following condition formula.

Assuming that the position of the center of an extracted inscribed circle is denoted as PE, the radius of an extracted inscribed circle is denoted as RE, the position of the center of an extraction-candidate inscribed circle is denoted as PC, the radius of an extraction-candidate inscribed circle is denoted as RC, and RE>RC, if the following formula (2) is satisfied, it is determined that there is no overlap.

RE+RC−H<L×RC (2)

In the above formula (2), H=|PE−PC| and L is a constant larger than 0. If L is set to be large, an inscribed circle whose degree of overlap with the extracted inscribed circle can be extracted as a candidate, but the efficiency decreases largely because machining is not performed during a subsequent tool movement. Therefore, it is desirable to appropriately set L according to the entire machining-area shape, machining conditions, and the like.

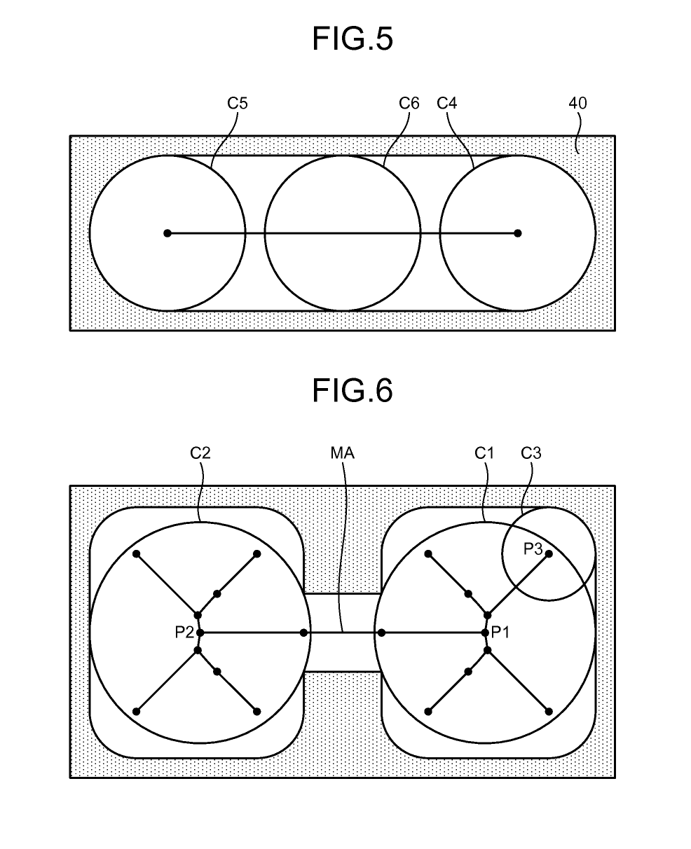

FIG. 6 shows an example of circle data to be extracted. In the example of FIG. 6, a circle C1 with a point P1 being a center thereof is extracted by the procedure (a) described above. Further, a circle C2 with a point P2 being a center thereof is extracted as an inscribed circle with the largest radius from an inscribed circle that is tangent to the contour of an entire machining-area shape at three or more points that do not overlap with the extracted circle C1 and an inscribed circle that is tangent to the contour of the entire machining-area shape at two points that do not overlap with the circle C2 by the procedure (b) described above. Because the circle C2 is extracted, the process returns from the procedure (c) to the procedure (b) again. When the procedure (b) is performed for the second time, there is no inscribed circle to be extracted.

This is because when the procedure (b) is performed for the second time, there is no inscribed circle that does not overlap with the extracted circles C1 and C2 among the extraction-candidate inscribed circles mentioned above. For example, a circle C3 with a point P3 being a center thereof is not extracted because the circle C3 overlaps with the circle C1, and other extraction-candidate inscribed circles are not extracted either. Eventually only the circles C1 and C2 are extracted and data of the circles C1 and C2 is stored in the spiral-machining-path reference-circle storage unit 22.

Then, toolpath data for machining a hole where spiral machining starts is generated in the hole-machining-path generation unit 5 and is stored in the tool-path storage unit 24 (Step S204). In this process, the coordinate of the center of the hole is obtained from the circle data stored in the spiral-machining-path reference-circle storage unit 22; and a hole machining path by a drill tool, a helical machining path by an end mill tool, and the like are generated based on the depth of a machining part, a machining method of a hole, and the radius of a hole stored in the machining-condition storage unit 21, and are stored.

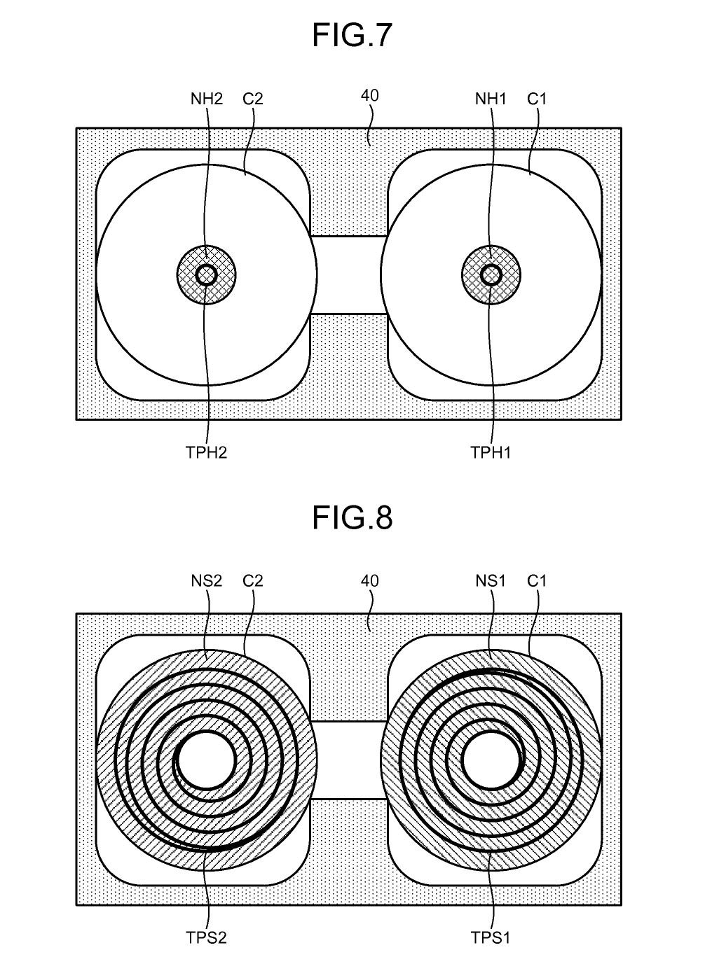

FIG. 7 shows an example of a hole machining path. As a machining method of a hole, helical machining by an end mill tool is specified. The circles C1 and C2 are obtained from the spiral-machining-path reference-circle storage unit 22, and tool paths for machining a hole area NH1 at the center of the circle C1 and a hole area NH2 at the center of the circle C2 are helical machining paths TPH1 and TPH2.

Then, spiral machining tool-path data is generated in the spiral-machining-path generation unit 6 and is stored in the tool-path storage unit 24 (Step S205). Data of an area shape that is a machining target in trochoidal machining is generated by the entire machining-area shape data stored in the machining-area-shape storage unit 20 and machining-area data obtained from a spiral machining path, and is stored in the trochoidal-machining-area shape storage unit 23.

A spiral machining tool path is generated based on circle data obtained from the spiral-machining-path reference-circle storage unit 22, the diameter of an end mill tool, a predetermined cutting amount in a tool radial direction, and a contact angle of a tool with respect to a machining material that are obtained from the machining-condition storage unit 21, and the like. For example, a spiral path is generated in such a manner that cutting starts from a side surface of a hole where machining starts, a cutting amount in a tool radial direction or a contact angle of a tool with respect to a machining material is increased to a predetermined value and is then maintained to be constant, and is reduced thereafter.

FIG. 8 shows generation of spiral machining. The circles C1 and C2 are obtained from the spiral-machining-path reference-circle storage unit 22. TPS1 and TPS2 are spiral machining paths for areas NS1 and NS2 that are machining targets on the machining material 40 in spiral machining corresponding to the circles.

FIG. 9 shows an example of an area shape that is a machining target in trochoidal machining. An area shape NT is an area shape obtained by removing areas of the circles C1 and C2 that are machining areas machined by a spiral machining path, from an entire machining-area shape.

Subsequently, in the trochoidal-machining-path generation unit 7, trochoidal machining path data is generated and is stored in the tool-path storage unit 24 (Step S206).

A tool path for trochoidal machining includes a method that generates a circular path in which a machining state and a non-machining state are repeated so that a cutting amount in a tool radius direction or a contact angle of a tool with respect to a machining material does not exceed a predetermined value is generated based on machining-area data obtained from the trochoidal-machining-area shape storage unit 23, the diameter of an end mill tool, a predetermined cutting amount in a tool radius direction, and a predetermined contact angle of a tool with respect to a machining material that are obtained from the machining-condition storage unit 21, and the like.

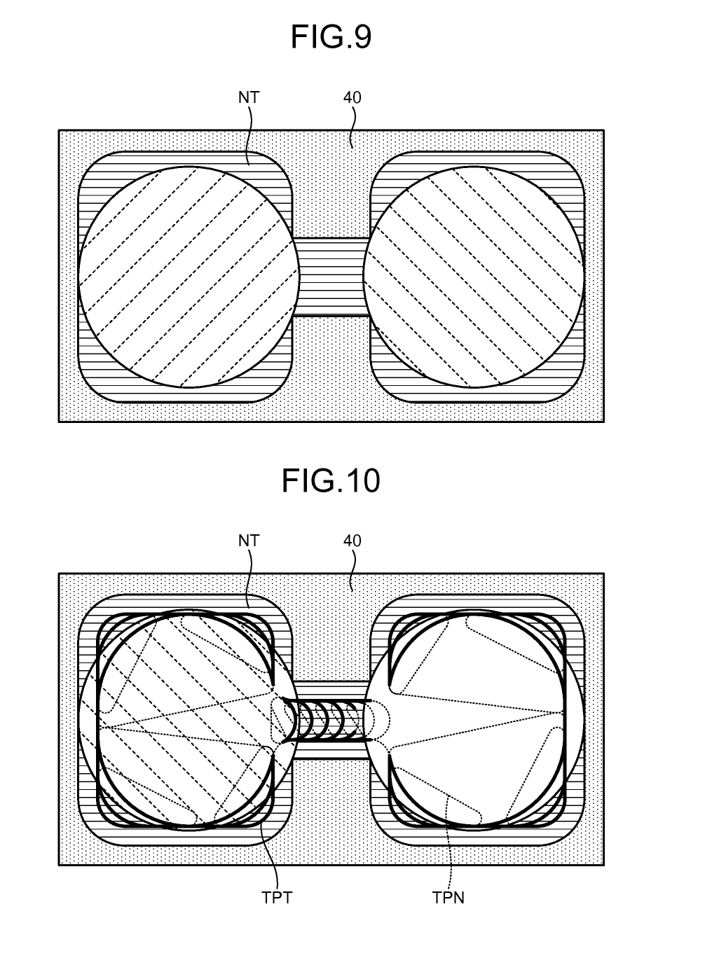

FIG. 10 shows an example of a machining path for trochoidal machining. A tool path for machining the area NT that is a machining target in FIG. 10 includes a path TPT in which the machining material 40 is machined and a path TPN in which the machining material 40 is not machined. In FIG. 10, the path TPT is shown by a solid line and the path TPN is shown by a broken line.

Subsequently, in the tool-path output unit 8, the order of hole machining path data, spiral machining path data, and trochoidal machining path data stored in the tool-path storage unit 24 is adjusted based on a machining method of a hole where hole machining and spiral machining start that is obtained from the machining-condition storage unit 21, and the data are output to outside.

For example, in a case that the machining method of a hole where hole machining and spiral machining start is drill machining by a drill tool, in view of reducing a loss due to tool replacement, all pieces of the hole machining path data are output first, all pieces of the spiral machining path data are output next, and the trochoidal machining path data is finally output.

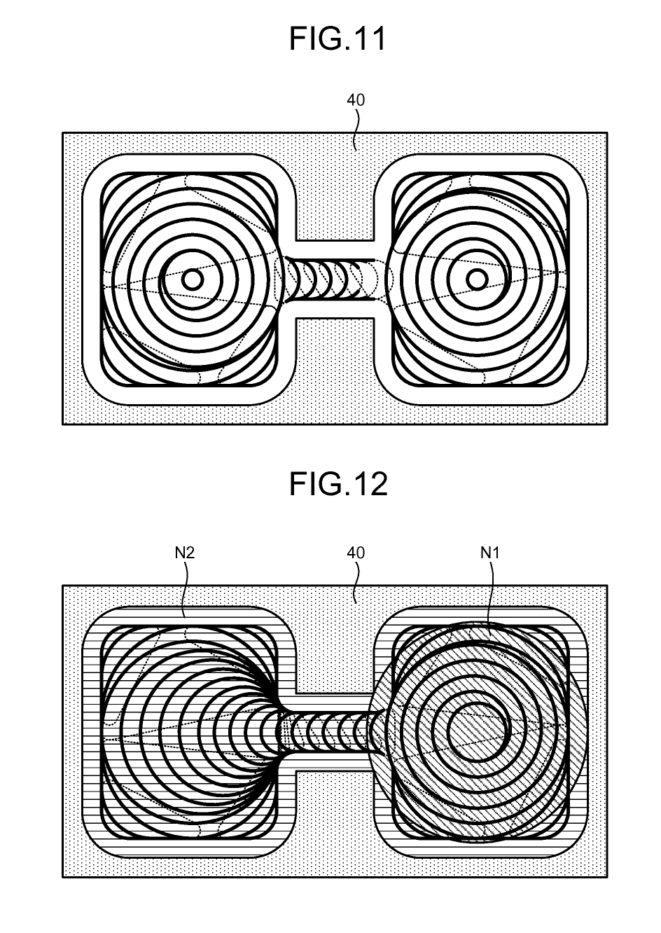

In a case that the machining method of a hole where hole machining and spiral machining start is helical machining by an end mill tool that is used in spiral machining and helical machining, the hole machining data and the spiral machining data that relate to the identical inscribed circle are output as a pair, and the trochoidal machining path data is finally output. FIG. 11 shows an example of a tool path as an output result. In FIG. 11, a solid line represents a path in which the machining material 40 is machined, and a broken line represents a path in which the machining material 40 is not machined.

After outputting tool path data at Step S207, the operation of the tool-path generation apparatus ends.

In the course of explaining the effects of the tool-path generation apparatus according to the present embodiment, for comparison, the tool-path generation apparatus disclosed in Patent Literature 1 will be explained.

FIG. 12 shows an example of a tool path generated by the tool-path generation apparatus disclosed in Patent Literature 1. FIG. 12 shows also a result of generating a tool path in the entire machining-area shape shown in FIG. 3. In FIG. 12, N1 denotes a circle area with the largest radius extracted from the entire machining area, and N2 denotes an area in which N1 is removed from the entire machining area. As a tool path, a spiral machining path is generated for N1 and a trochoidal machining path is generated for N2. In FIG. 12, a solid line represents a path in which the machining material 40 is machined, and a broken line represents a path in which the machining material 40 is not machined.

One of rectangular areas that constitute the entire machining area corresponds to the circle area N1, and machining is continuously performed by spiral machining at high efficiency in the area. Machining is discontinuously performed by using a trochoidal machining path in the other of the rectangular areas, and thus the machining efficiency of the other rectangular area is lower than that of the rectangular area in which machining is continuously performed by spiral machining.

On the other hand, according to the present embodiment, machining is performed by using a spiral machining path also in the other rectangular area, and thus machining is performed at higher efficiency as a whole.

While a case where the entire machining-area shape has a constricted portion has been exemplified here, however in a case an aspect ratio of the entire machining-area shape is significantly high, in the tool-path generation apparatus disclosed in Patent Literature 1, spiral machining is performed on only the largest circle part in the entire machining-area shape, and thus the effect of efficiency improvement of machining by spiral machining cannot be obtained sufficiently. On the other hand, even if the aspect ratio of the entire machining-area shape is significantly high, the tool-path generation apparatus according to the present embodiment extracts a plurality of circles from the entire machining-area shape and performs spiral machining on the extracted circle areas, so that the effect of efficiency improvement of machining is increased.

While a case of generating a machining path for machining a part that remains after spiral machining in a trochoidal shape has been exemplified in the above embodiment, the machining path may be formed in a zigzag or meander shape.

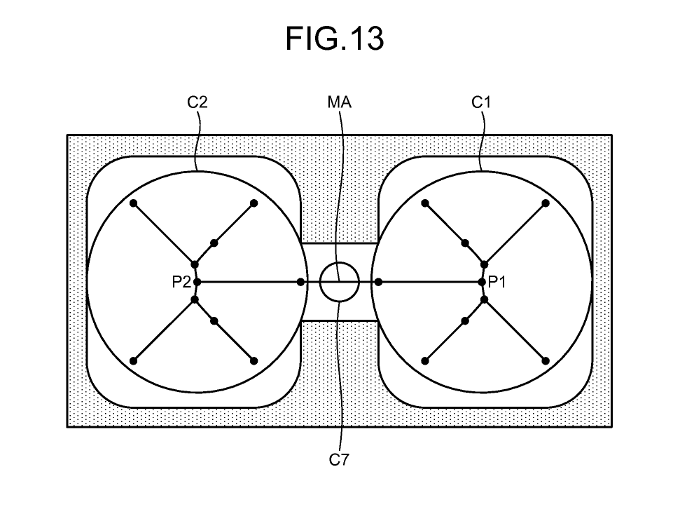

In the above embodiment, it has been explained that, at the time of extracting circle data, an inscribed circle with the largest radius in inscribed circles that have a radius larger than a predetermined value and do not overlap with an extracted inscribed circle is extracted from inscribed circles that are tangent to the contour of the entire machining-area shape at two points. However, a circle that is not tangent to the contour of the entire machining-area shape at two points may be extracted. FIG. 13 shows an example of a case of extracting a circle that is not tangent to the contour of the entire machining-area shape at two points. As shown in FIG. 13, when a circle C7 that does not overlap with the circles C1 and C2 is extracted between the circles C1 and C2, the circle C7 becomes a circle that is not tangent to the contour of the entire machining-area shape at two points. However, spiral machining may be performed within the circle C7. Further, it is also possible that the spiral-machining-path generation unit 6 generates a tool path for performing spiral machining in an area including a circumference of an extracted circle.

### INDUSTRIAL APPLICABILITY

As described above, the tool-path generation apparatus and the tool-path generation method according to the present invention are useful in being capable of realizing efficiency improvement by automatically applying a plurality of spiral paths according to an entire machining-area shape.

### REFERENCE SIGNS LIST

1 machining-area-shape input unit, 2 machining-condition input unit, 3 tool-path generation unit, 4 spiral-machining-path reference-circle generation unit, 5 hole-machining-path generation unit, 6 spiral-machining-path generation unit, 7 trochoidal-machining-path generation unit, 8 tool-path output unit, 20 machining-area-shape storage unit, 21 machining-condition storage unit, 22 spiral-machining-path reference-circle storage unit, 23 trochoidal-machining-area shape storage unit, 24 tool-path storage unit, 25 control unit, 40 machining material, 50 tool-path generation apparatus.

1. A tool-path generation apparatus that generates a tool path for forming a concave part that is defined by an entire machining-area shape and a depth into a machining material, the tool-path generation apparatus comprising:
a reference-circle generation unit that extracts a plurality of circular areas that satisfy a preset condition from the entire machining-area shape;
a first machining-path generation unit that generates a first tool path for machining the circular areas extracted by the reference-circle generation unit or an area that includes a circumference of the circular areas by using a spiral path and a machining-area shape after spiral machining in which a machining area by the first tool path is removed from the entire machining-area shape; and
a second machining-path generation unit that generates a second tool path for machining the machining-area shape after spiral machining.

2. The tool-path generation apparatus according to claim 1, wherein the second machining-path generation unit generates the second tool path in a trochoidal shape.

3. The tool-path generation apparatus according to claim 1, wherein the reference-circle generation unit limits degree of overlaps to a preset value or less so as to extract a plurality of circular areas from the entire machining-area shape.

4. The tool-path generation apparatus according to claim 1, wherein the reference-circle generation unit extracts a circle that is inscribed on a contour of the entire machining-area shape at two or more points.

5. The tool-path generation apparatus according to claim 1, wherein
the reference-circle generation unit extracts a first inscribed circle with a largest radius from a plurality of inscribed circles in the entire machining-area shape, and
after extracting the first inscribed circle, from a second inscribed circle that is tangent to a contour of the entire machining-area shape at three or more points and a third inscribed circle that does not overlap with the second inscribed circle and is tangent to the contour of the entire machining-area shape at two points, the reference-circle generation unit repeatedly extracts an inscribed circle with a largest radius in inscribed circles that have a radius larger than a preset value based on a tool diameter and in which degree of overlaps with the extracted first, second, and third inscribed circles is equal to or less than a preset value.

6. A tool-path generation method of generating a tool path for forming a concave part that is defined by an entire machining-area shape and a depth into a machining material, the tool-path generation method comprising:
a reference-circle generation step of extracting a plurality of circular areas that satisfy a preset condition from the entire machining-area shape;
a first machining-path generation step of generating a first tool path for machining the circular areas extracted in the reference-circle generation step or an area that includes a circumference of the circular areas by using a spiral path and a machining-area shape after spiral machining in which a machining area by the first tool path is removed from the entire machining-area shape; and
a second machining-path generation step of generating a second tool path for machining the machining-area shape after spiral machining.
